(19) United States
(12) Patent Application Publication
(10) Pub. No.: US 2017/0318305 A1
(43) Pub. Date: Nov. 2, 2017

(54) PREDICTION-IMAGE GENERATION DEVICE AND PREDICTION-IMAGE GENERATION METHOD

(71) Applicant: NEC CORPORATION, Tokyo (JP)

(72) Inventor: Eita KOBAYASHI, Tokyo (JP)

(73) Assignee: NEC CORPORATION, Tokyo (JP)

(21) Appl. No.: 15/523,158

(22) PCT Filed: Oct. 20, 2015
(86) PCT No.: PCT/JP2015/005273

§ 371 Date: Apr. 28, 2017

(30) Foreign Application Priority Data
Oct. 31, 2014 (JP) 2014-222747

(51) Int. Cl. H04N 19/436; H04N 19/105; H04N 19/159; H04N 19/182

(52) U.S. Cl. CPC H04N 19/436; H04N 19/182; H04N 19/105; H04N 19/159

(57) ABSTRACT

[Problem] To obtain a prediction-image generation device capable of generating an intra prediction image in parallel processing while suppressing a circuit size.

[Solution to Problem] A prediction-image generation device includes a storage means 1, a selection means 2, a prediction-pixel generation means 3, and a rearrangement buffer means 4. The storage means 1 holds a plurality of reference pixels. The selection means 2 selects, as a necessary reference pixel, a reference pixel used for generating an intra prediction image, based on a mode number and a pixel position. The prediction-pixel generation means 3 generates a plurality of prediction pixels in parallel processing, based on the necessary reference pixel. The rearrangement buffer means 4 generates the prediction image by rearranging the prediction pixels generated by the prediction-pixel generation means 3, based on a mode number.

### TECHNICAL FIELD

The present invention relates to coding of moving images, and more particularly, to generation of an intra prediction image during coding.

### BACKGROUND ART

High-quality videos are delivered via broadcasting, communication lines or the like and have been used for a video display device and an information terminal device. Image data constituting these high-quality videos are used after being coded by a transmission side and decoded by a terminal device or the like which is a reception side. In order to transmit high-quality videos, vast amounts of image data are required. Therefore, it is desirable to perform coding at high speed with a high compression efficiency. Since a size of a device that processes vast amounts of image data at high speed is large, it is desirable to suppress a circuit size in each functional unit for coding image data. Under such circumstances, related techniques for moving image coding for transmitting high-quality videos have been vigorously developed. For example, NPL 1 discloses a technique relating to cording of moving images.

NPL 1 describes HEVC (High Efficiency Video Coding) standard which is a video coding system based on ITU-T (International Telecommunication Union Telecommunication Standardization Sector) Recommendation H.265 standard. In the HEVC standard, each frame of digitized videos is divided into a coding tree unit (CTU). Each CTU is coded in a raster scan order. Each CTU is divided into a coding unit (CU) and subjected to coding in a quadtree structure. During coding, each CU is divided into a prediction unit (PU) and subjected to prediction coding.

During coding, each CU is subjected to prediction coding by intra prediction or inter prediction. The intra prediction is a prediction for generating a prediction image from a reference image of a coding target frame. The HEVC standard defines 33 types of angular intra predictions. The angular intra prediction is a prediction method in which a reference pixel in the vicinity of a coding target block is extrapolated to any one of 33 types of directions, and a prediction pixel is generated. The HEVC standard defines not only 33 types of angular intra predictions, but also a DC (Discrete Cosine) intra prediction for averaging reference pixels in the vicinity of a coding target block, and a planner intra prediction for linearly interpolating reference pixels in the vicinity of a coding target block.

Reference pixels in the vicinity of the coding target block are held in a storage element such as a register on a circuit. A circuit for generating a prediction image generates a prediction pixel with reference to a reference pixel located at an appropriate position for generating the prediction pixel. In the case of the HEVC standard, there are 129 reference pixels at maximum. Accordingly, a selector for selecting a predetermined number of reference pixels from the 129 reference pixels at maximum is required to generate the prediction pixel.

In order to reduce time required for image processing from a demand for high-speed processing, a technique in which image processing circuits are arranged in parallel and processing is performed in parallel may be employed. For example, PTL 1 discloses a technique for performing image processing in parallel.

PTL 1 discloses a technique relating to an image processing device that performs image data processing in parallel. The image processing device in PTL 1 includes a line memory that holds image data, a vertical filter processing unit, a buffer, and a horizontal filter processing unit. In PTL 1, respective pixel data stored in the line memory are input to a vertical filter processing unit and processed in parallel in the vertical filter processing unit. The data processed by the vertical filter processing unit are sent to the horizontal filter processing unit and predetermined image processing is performed on the data in parallel. PTL 1 describes that the above-mentioned configuration can eliminate need for providing a buffer for absorbing vertical and horizontal differences and makes it possible to reduce a circuit area.

### CITATION LIST

### Patent Literature

[PTL 1] International Publication No. WO 2007/072644

### Non Patent Literature

[NPL 1] ITU-T Recommendation H.265 High efficiency video coding, April 2013

### SUMMARY OF INVENTION

### Technical Problem

However, the techniques in NPL 1 and PTL 1 are not sufficient for the following reasons. A prediction-image generation device used for prediction coding processing includes a plurality of prediction-pixel generation circuits for obtaining a practical processing speed and performs processing of generating prediction pixels in parallel. The prediction-image generation device sequentially generates prediction pixels respectively corresponding to pixels of a prediction image, thereby generating the prediction image.

When the prediction pixels are generated, it is necessary to select necessary reference pixels for each prediction-pixel generation circuit and to input the selected reference pixels to each prediction-pixel generation circuit. For example, in the case based on the HEVC standard, it is necessary for a selector to select, from 129 reference pixels at maximum, reference pixels necessary for generating the prediction pixels and to input the selected reference pixels to each prediction-pixel generation circuit.

However, assuming that the configuration includes a selector for selecting, for each prediction-pixel generation circuit, a predetermined number of reference pixels from 129 reference pixels at maximum, a circuit size increases. Accordingly, the techniques in NPL 1 and PTL 1 are not sufficient as a technique for generating a prediction image in parallel processing while suppressing a circuit size.

In order to solve the above-mentioned problems, an object of the present invention is to obtain a prediction-image generation device capable of generating an intra prediction image in parallel processing, while suppressing a circuit size.

### Solution to Problem

In order to solve the above-mentioned problems, a prediction-image generation device according to the present invention includes a storage means, a selection means, a prediction-pixel generation means, and a rearrangement buffer means. The storage means holds a plurality of reference pixels. The selection means selects, as a necessary reference pixel, a reference pixel used for generating an intra prediction image, based on a mode number and a pixel position. The prediction-pixel generation means generates a plurality of prediction pixels in parallel processing, based on the necessary reference pixels. The rearrangement buffer means generates the prediction image by rearranging the prediction pixels, which are generated by the prediction-pixel generation means, based on the mode number.

Further, a prediction-image generation method according to the present invention includes: holding a plurality of reference pixels; and selecting, as a necessary reference pixel, a reference pixel used for generating an intra prediction image, based on a mode number and a pixel position. The prediction-image generation method according to the present invention further includes: generating a plurality of prediction pixels in parallel processing, based on the necessary reference pixels; and generating the prediction image by rearranging the generated prediction pixels, based on the mode number.

### Advantageous Effects of Invention

According to the present invention, it is possible to generate an intra prediction image in parallel processing while suppressing a circuit size.

### BRIEF DESCRIPTION OF DRAWINGS

FIG. 1 is a diagram illustrating an outline of a configuration of a first example embodiment of the present invention;

FIG. 2 is a diagram illustrating an outline of a configuration of a device according to a second example embodiment of the present invention;

FIG. 3 is a diagram illustrating mode numbers and directions in intra prediction of the HEVC standard;

FIG. 4 is a flowchart illustrating an outline of an operation flow according to the second example embodiment of the present invention;

FIG. 5 is a diagram illustrating an example of a configuration of a device according to the second example embodiment of the present invention;

FIG. 6 is a diagram illustrating a detailed configuration of a part of the device according to the second example embodiment of the present invention;

FIG. 7 is a diagram illustrating a detailed configuration of a part of the device according to the second example embodiment of the present invention;

FIG. 8 is a diagram illustrating a detailed configuration of a part of the device according to the second example embodiment of the present invention;

FIG. 9 is a diagram illustrating an example of positions where data are stored according to the second example embodiment of the present invention;

FIG. 10 is a diagram illustrating an example of positions where data are stored according to the second example embodiment of the present invention;

FIG. 11 is a flowchart illustrating an example of an operation flow according to the second example embodiment of the present invention;

FIG. 12 is a diagram illustrating an outline of a configuration according to a third example embodiment of the present invention;

FIG. 13 is a diagram illustrating a detailed configuration of a part of a device according to the third example embodiment of the present invention;

FIG. 14 is a flowchart illustrating an outline of an operation flow according to the third example embodiment of the present invention;

FIG. 15 is a diagram illustrating an example of a configuration of a device according to the third example embodiment of the present invention;

FIG. 16 is a diagram illustrating a detailed configuration of a part of the device according to the third example embodiment of the present invention;

FIG. 17 is a flowchart illustrating an example of an operation flow according to the third example embodiment of the present invention; and

FIG. 18 is a diagram illustrating an outline of a configuration of a moving image coding device.

### DESCRIPTION OF EMBODIMENTS

### First Example Embodiment

### Configuration of First Example Embodiment

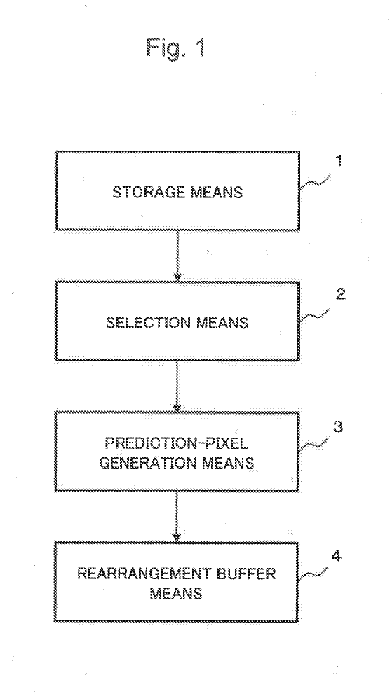

A first example embodiment of the present invention will be described in detail with reference to the drawings. FIG. 1 illustrates an outline of a configuration of a prediction-image generation device according to this example embodiment. The orientations of arrows between blocks in FIG. 1 and subsequent figures are illustrated by way of example and are not intended to limit the directions of signals between blocks. The prediction-image generation device of this example embodiment includes a storage means 1, a selection means 2, a prediction-pixel generation means 3, and a rearrangement buffer means 4.

The storage means 1 holds a plurality of reference pixels. The selection means 2 selects, as necessary reference pixels, the reference pixels used for generating an intra prediction image, on the basis of a mode number and a pixel position. The prediction-pixel generation means 3 generates a plurality of prediction pixels in parallel processing based on the necessary reference pixels. The rearrangement buffer means 4 generates a prediction image by rearranging the prediction pixels, which are generated by the prediction-pixel generation means 3, on the basis of the mode number.

### Advantageous Effects of First Example Embodiment

In the prediction-image generation device of this example embodiment, the prediction-pixel generation means 3 generates a plurality of prediction pixels in parallel processing based on the necessary reference pixels selected by the selection means 2. The rearrangement buffer means 4 generates a prediction image by rearranging the prediction pixels. Thus, the necessary reference pixels selected by the selection means 2 are input to the prediction-pixel generation means 3, and prediction pixels are generated in parallel processing and then a prediction image is generated by rearranging the prediction pixels, thereby eliminating the need for providing a circuit, such as a selector, for each prediction pixel at the pre-stage of the prediction-pixel generation means 3. Therefore, a circuit area required for providing a plurality of selectors and the like can be suppressed. As a result, the prediction-image generation device of this example embodiment can generate an intra prediction image in parallel processing while suppressing the circuit size.

### Second Example Embodiment

### Configuration of Second Example Embodiment

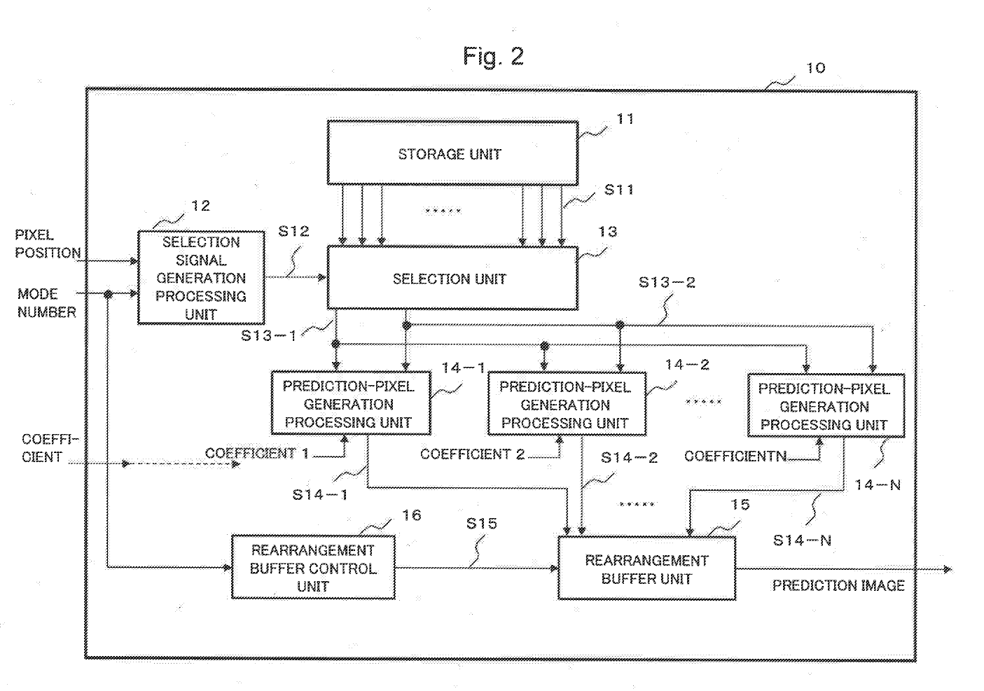

A second example embodiment of the present invention will be described in detail with reference to the drawings. FIG. 2 illustrates an outline of a configuration of an intra prediction-image generation device 10 of this example embodiment. The intra prediction-image generation device 10 of this example embodiment is a device that generates intra prediction images during coding of moving images. The intra prediction-image generation device 10 of this example embodiment generates prediction pixels, which are generated from the same reference pixels, in parallel processing, holds the generated prediction pixels in a buffer, and then rearranges the prediction pixels, thereby generating a prediction image. The intra prediction-image generation device 10 of this example embodiment can suppress the circuit area as compared with the configuration of sequentially selecting the reference pixels respectively corresponding to the prediction pixels constituting the prediction image.

The intra prediction-image generation device 10 of this example embodiment includes a storage unit 11, a selection signal generation processing unit 12, a selection unit 13, a prediction-pixel generation processing unit 14, a rearrangement buffer unit 15, and a rearrangement buffer control unit 16. N prediction-pixel generation processing units 14, i.e., prediction-pixel generation processing units 14-1 to 14-N, are provided. N is an integer and corresponds to N coefficients that are externally input, i.e., coefficients 1 to N.

The storage unit 11 has a function of holding reference pixel data. The storage unit 11 stores the reference pixel data to be referred to when the prediction image is generated. The reference pixels are pixels in the vicinity of a block for generating the prediction pixel, and are referred to when prediction pixels of a target block for generating the prediction pixels are generated. The reference pixel data stored in the storage unit 11 are sent to the selection unit 13 as a reference pixel signal S11 for each data of one pixel. The storage unit 11 corresponds to the storage means 1 of the first example embodiment.

The storage unit 11 can be configured using, for example, a semiconductor storage element. As the semiconductor storage element used for the storage unit 11, for example, a register, a flip-flop and the like can be used. As the storage unit 11, an SRAM (Static Random Access Memory), a DRAM (Dynamic Random Access Memory), a PRAM (Phase Shifter Random Access Memory), and other semiconductor storage elements can be used. As the storage unit 11, devices such as a flash memory, an SSD (Solid State Drive), and a hard disk can also be used.

The selection signal generation processing unit 12 has a function of generating a control signal for selecting reference pixels. The selection signal generation processing unit 12 generates, as a selection signal S12, the control signal for selecting reference pixels on the basis of information indicating a pixel position and a mode number externally input.

The selection unit 13 has a function of selecting, on the basis of the selection signal S12, a reference pixel to be sent to the prediction-pixel generation processing unit 14 from the storage unit 11. The selection unit 13 receives the reference pixel data held by the storage unit 11 as the reference pixel signal S11 for each data of one pixel. Specifically, the selection unit 13 receives a plurality of reference pixel signals S11 from the storage unit 11. The selection unit 13 selects, on the basis of the selection signal S12, two signals from among the reference pixel signals S11 received from the storage unit 11, and sends, as a necessary reference pixel signal S13, data of the selected reference pixel signals S11 to the prediction-pixel generation processing unit 14. In this example embodiment, data of two necessary reference pixels are sent to each prediction-pixel generation processing unit 14 as necessary reference pixel signals S13-1 and S13-2. The selection unit 13 corresponds to the selection means 2 of the first example embodiment.

The prediction-pixel generation processing unit 14 has a function of generating prediction pixels based on the reference pixels input from the selection unit 13 and the coefficients externally input. The prediction-pixel generation processing units 14, i.e., the prediction-pixel generation processing units 14-1 to 14-N generate prediction pixels based on the data of the necessary reference pixels, which are input as the necessary reference pixel signals S13-1 and S13-2 from the selection unit 13, and the coefficients externally input. At the same timing, the reference pixels input to the respective prediction-pixel generation processing units 14 are the same pixel data. Specifically, the prediction-pixel generation processing units 14 receive the same necessary reference pixel signals S13-1 and S13-2. The prediction-pixel generation processing units 14 respectively generate prediction pixels based on the respective input coefficients.

Each prediction-pixel generation processing unit 14 outputs the data of the generated prediction pixels to the rearrangement buffer unit 15 as a prediction pixel signal S14. Specifically, the data of prediction pixels generated by the N prediction-pixel generation processing units 14, respectively, are output as prediction pixel signals S14-1 to S 14-N, respectively, to the rearrangement buffer unit 15. The prediction-pixel generation processing unit 14 corresponds to the prediction-pixel generation means 3 of the first example embodiment.

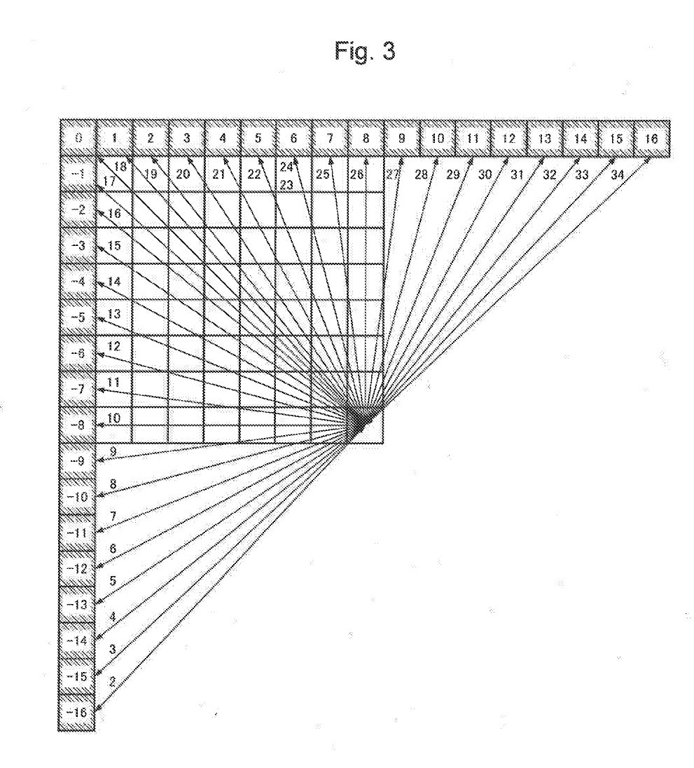

The intra prediction is a prediction method for obtaining a prediction image by generating prediction pixels from a reference image of a coding target frame. The HEVC standard defines 33 types of angular intra prediction illustrated in FIG. 3. In the angular intra prediction, prediction pixels are generated by extrapolating reference pixels in the vicinity of a coding target block to any one of the 33 types of directions illustrated in FIG. 3.

In FIG. 3, each rectangle in the uppermost row and each rectangle in the leftmost column represent reference pixels. Numbers in the respective rectangles represent coordinates. Each arrow indicates a prediction direction. Numbers given in the vicinity of the respective arrows indicate numbers of prediction modes. Hereinafter, the prediction modes are referred to as modes. The reference pixels in the vicinity of the coding target block are held by a storage element, such as a register. When prediction pixels are generated, the prediction pixels are generated by referring to the reference pixels located at appropriate positions. In the angular intra prediction, prediction pixels PredSamples[x][y] are calculated by, for example, the following formula.

PredSamples[x][y]=((32-iFact)*ref[x+iIdx+1]+iFact*ref[x+iIdx+2]+16>>5 (Formula 1)

where x and y represent coordinates of pixel positions of prediction pixels in a prediction block. Each of ref[x+iIdx+1] and ref[x+iIdx+2] represents an array of reference pixels, and the position of each reference pixel is represented by an index of the array. Each of ref[x+iIdx+1] and ref[x+iIdx+2] represents a reference pixel located at a position determined by the target block size and the pixel position in the block. iIdx is calculated by iIdx=((y+1)*PredAngle). PredAngle represents an angle determined for each prediction mode. Further, iFact is calculated by iFact=((y+1)*PredAngle) & 31. “&31” represents a bit AND calculation with “11111” which is a binary representation of 31. iFact represents a coefficient having the same value in each row in the block for each prediction mode. “>>5” represents a 5-bit right shift operation in a binary digit. For all (x, y) in the prediction block, PredSamples[x][y] are obtained by the above-mentioned (Formula 1), thereby making it possible to generate a prediction image of the prediction block.

The rearrangement buffer unit 15 has a function of holding the data of input prediction pixels and generating a prediction image by appropriately rearranging the prediction pixels. The rearrangement buffer unit 15 receives, from the N prediction-pixel generation processing units 14, the data of the prediction pixels as N prediction pixel signals S14, and holds the received data of N prediction pixels. The rearrangement buffer unit 15 holds the data of N prediction pixels one or a plurality of times. The rearrangement buffer unit 15 generates, on the basis of a rearrangement control signal S15, the prediction image by appropriately rearranging the held prediction pixels for each mode number. The number of times of holding the data of prediction pixels by the rearrangement buffer unit 15 is set, for example, as the number of times required for generating all intra prediction pixels necessary for generating the intra prediction image of the coding target block. The number of times of holding the data of prediction pixels by the rearrangement buffer unit 15 may be set as the number of times required for generating the intra prediction pixels necessary for generating the intra prediction image of a partial block when the coding target block is divided.

As the rearrangement buffer unit 15, for example, a register having a shift function, such as a ring register or a shift register, or a storage element, such as a flip-flop, can be used. As the rearrangement buffer unit 15, a register including a rearrangement mechanism or a storage element such as a flip-flop can also be used. As the rearrangement buffer unit 15, a semiconductor storage element including a rearrangement mechanism, such as an SRAM, a DRAM, or a PRAM, can also be used. As the rearrangement buffer unit 15, a flash memory including a rearrangement mechanism, or a device such as an SSD (Solid State Drive) or a hard disk can also be used. As the rearrangement buffer unit 15, devices such as a randomly accessible SRAM, DRAM, PRAM, a flash memory, SSD, or a hard disk can also be used. The rearrangement buffer unit 15 corresponds to the rearrangement buffer means 4 of the first example embodiment.

The rearrangement buffer control unit 16 has a function of generating the rearrangement control signal S15 based on the mode number externally input. The rearrangement buffer control unit 16 receives the mode number externally input, and generates, as the rearrangement control signal S15, a control signal for generating the prediction image disposed appropriately depending on the mode number for each mode number. The rearrangement buffer control unit 16 sends the generated rearrangement control signal S15 to the rearrangement buffer unit 15.

### Operation of Second Example Embodiment

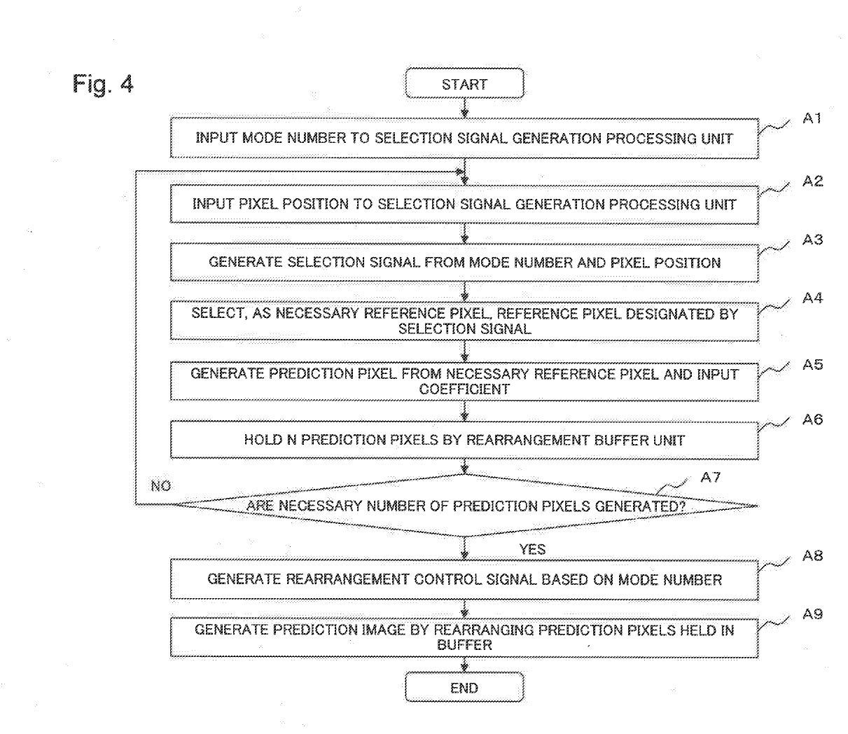

Next, the operation of the intra prediction-image generation device 10 of this example embodiment will be described with reference to the flowchart of FIG. 4. FIG. 4 illustrates a flowchart of an outline of an operation flow of the intra prediction-image generation device 10 of this example embodiment.

First, a signal indicating information about a mode number is externally input to the selection signal generation processing unit 12 (step A1). A signal indicating information about a pixel position is input to the selection signal generation processing unit 12 (step A2). Upon receiving the information about the mode number and the pixel position, the selection signal generation processing unit 12 generates the selection signal S12 based on the received information about the mode number and the pixel position (step A3).

A signal indicating pixel data of reference pixels is sent from the storage unit 11 to the selection unit 13 as the reference pixel signal S11. As the reference pixel signal S11 indicating pixel data of reference pixels, one signal per reference pixel is sent to the selection unit 13. In other words, the selection unit 13 receives the reference pixel signal S11 indicating the reference pixels from the storage unit 11 a plurality of times. Upon receiving the selection signal S12, the selection unit 13 selects two signals designated by the selection signal S12 from the reference pixel signal S11 indicating the reference pixels (step A4). The two reference pixels selected by the selection unit 13 are input as the necessary reference pixel signals S13-1 and S13-2, respectively, to the N prediction-pixel generation processing units 14, i.e., the prediction-pixel generation processing units 14-1 to 14-N. At this time, the N prediction-pixel generation processing units 14 from the prediction-pixel generation processing unit 14-1 to the prediction-pixel generation processing unit 14-N, commonly receive the two necessary reference pixel signals S13-1 and S13-2 selected by the selection unit 13.

A signal indicating information about a coefficient is externally input to each of the N prediction-pixel generation processing units 14. Upon receiving the necessary reference pixel signals S13-1 and S13-2, the N prediction-pixel generation processing units 14 each generate prediction pixels based on the externally input coefficient and the necessary reference pixel signals S13-1 and S13-2. Specifically, the N prediction-pixel generation processing units 14 from the prediction-pixel generation processing unit 14-1 to the prediction-pixel generation processing unit 14-N, generate N prediction pixels in total (step A5). Upon generating the prediction pixels, the N prediction-pixel generation processing units 14 each send data of the generated prediction pixels to the rearrangement buffer unit 15 as the prediction pixel signal S14. Specifically, data of the N prediction pixels of the prediction pixel signals S14-1 to S14-N are sent to the rearrangement buffer unit 15.

Upon receiving data of prediction pixels respectively from the prediction-pixel generation processing units 14 as the prediction pixel signal S14, the rearrangement buffer unit 15 holds the received data of the prediction pixels. Specifically, the rearrangement buffer unit 15 holds the data of the N prediction pixels (step A6).

When the data of the prediction pixels are held, the rearrangement buffer unit 15 determines whether or not all the prediction pixels necessary for generating an intra prediction image of the target block have been received. When the prediction pixels necessary for generating the intra prediction image are not generated (No in step A7), the rearrangement buffer unit 15 stands by until the necessary prediction pixels are held. When the result shows No in step A7, that is, when the necessary number of prediction pixels in the block are not generated, the process returns to step A2 to obtain information about the next pixel position, and the operation from step A2 to step A6 is carried out. In step A2, the mode number in the same coding target block is not changed, and thus the mode number obtained in step A1 is continuously used.

When all the prediction pixels necessary for generating the intra prediction image are generated (Yes in step A7), the intra prediction-image generation device 10 carries out the operation of generating the prediction image in step A8 and subsequent steps.

The rearrangement buffer control unit 16 generates, as the rearrangement control signal S15, a signal for designating the order of rearrangement when the rearrangement buffer unit 15 generates the intra prediction image by rearranging the prediction pixels on the basis of the input mode number (step A8). Upon generating the rearrangement control signal S15, the rearrangement buffer control unit 16 sends the generated rearrangement control signal S15 to the rearrangement buffer unit 15.

Upon receiving the rearrangement control signal S15, the rearrangement buffer unit 15 rearranges the prediction pixels, which are held in the rearrangement buffer unit 15, in the order designated by the rearrangement control signal S15, generates the intra prediction image of the block, and outputs the generated intra prediction image (step A9). When there are other blocks including the prediction image that is not generated, the above-described operation is sequentially repeated for the other blocks. The above describes the operation of the intra prediction-image generation device 10 of this example embodiment.

### Advantageous Effects of Second Example Embodiment

In the intra prediction-image generation device 10 of this example embodiment, the selection unit 13 selects necessary reference pixels, and the reference pixel data are input to the plurality of prediction-pixel generation processing units 14 in parallel. Therefore, in the intra prediction-image generation device 10 of this example embodiment, the prediction pixels can be simultaneously generated using the same reference pixels. With this configuration, the number of selectors necessary for inputting the reference pixels to the prediction-pixel generation processing unit 14 can be reduced, and thus the circuit configuration can be simplified. Further, the simplification of the circuit configuration leads to a reduction in circuit area.

Further, in the intra prediction-image generation device 10 of this example embodiment, the rearrangement buffer unit 15 holds the N prediction pixels simultaneously generated. The rearrangement buffer unit 15 holds a number of prediction pixels necessary for generating the intra prediction image, and then rearranges the prediction pixels according to the control signal based on the mode number, thereby generating the intra prediction image. This configuration can eliminate the need for providing a selector necessary for generating the intra prediction image of the block that performs processing from the generated prediction pixels, and can simplify the circuit configuration, which leads to a reduction in circuit area.

### Specific Examples of Second Example Embodiment

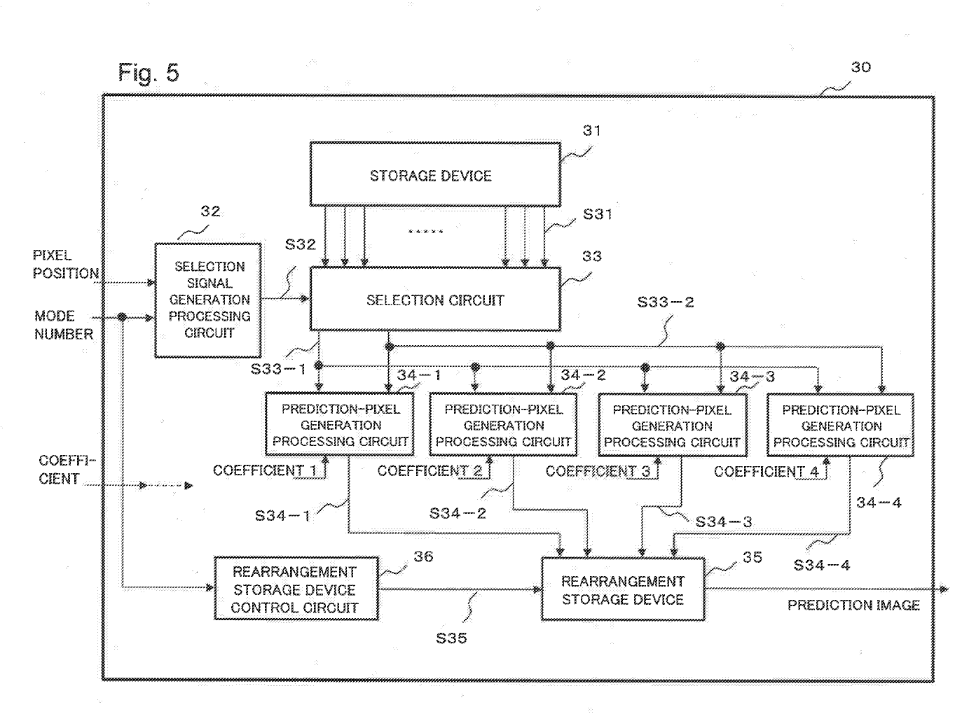

Next, the intra prediction-image generation device 10 of this example embodiment will be described using more specific examples. FIG. 5 illustrates an outline of a configuration of an intra prediction-image generation circuit 30 which constitutes the intra prediction-image generation device 10 of this example embodiment.

As illustrated in FIG. 5, the intra prediction-image generation circuit 30 includes a storage device 31, a selection signal generation processing circuit 32, a selection circuit 33, a prediction-pixel generation processing circuit 34, a rearrangement storage device 35, and a rearrangement storage device control circuit 36. Further, the intra prediction-image generation circuit 30 includes four prediction-pixel generation processing circuits 34 from a prediction-pixel generation processing circuit 34-1 to a prediction-pixel generation processing circuit 34-4.

The intra prediction-image generation circuit 30 corresponds to the intra prediction-image generation device 10 when N=4 holds. The storage device 31 corresponds to the storage unit 11 of the intra prediction-image generation device 10. The selection signal generation processing circuit 32 corresponds to the selection signal generation processing unit 12 of the intra prediction-image generation device 10. The selection circuit 33 corresponds to the selection unit 13 of the intra prediction-image generation device 10. The prediction-pixel generation processing circuit 34 corresponds to the prediction-pixel generation processing unit 14 of the intra prediction-image generation device 10. The rearrangement storage device 35 corresponds to the rearrangement buffer unit 15 of the intra prediction-image generation device 10. The rearrangement storage device control circuit 36 corresponds to the rearrangement buffer control unit 16 of the intra prediction-image generation device 10.

The reference pixel signal S31 corresponds to the reference pixel signal S11. A selection signal S32, a necessary reference pixel signal S33, a prediction pixel signal S34, and a rearrangement control signal S35 correspond to the selection signal S12, the necessary reference pixel signal S13, the prediction pixel signal S14, and the rearrangement control signal S15, respectively.

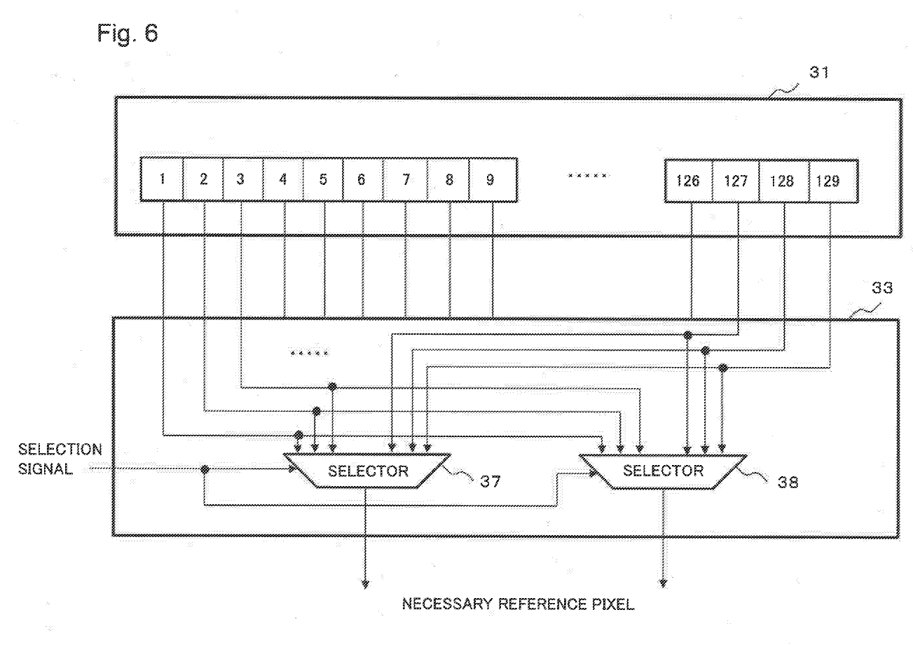

FIG. 6 illustrates an example of configurations of the storage device 31 and the selection circuit 33. The storage device 31 is configured using a plurality of registers, and has a function of holding data of one reference pixel for each register. FIG. 6 illustrates an example in which 129 registers are provided. The storage device 31 can hold 129 reference pixels at maximum.

The selection circuit 33 includes a selector 37 and a selector 38. To the selector 37 and the selector 38, 129 signal lines are each input from the 129 registers of the storage device 31. The selector 37 and the selector 38 each select one signal line from among the 129 signal lines on the basis of the selection signal S32, and output, as the necessary reference pixel signal S33, the data of the reference pixel input from the selected signal line.

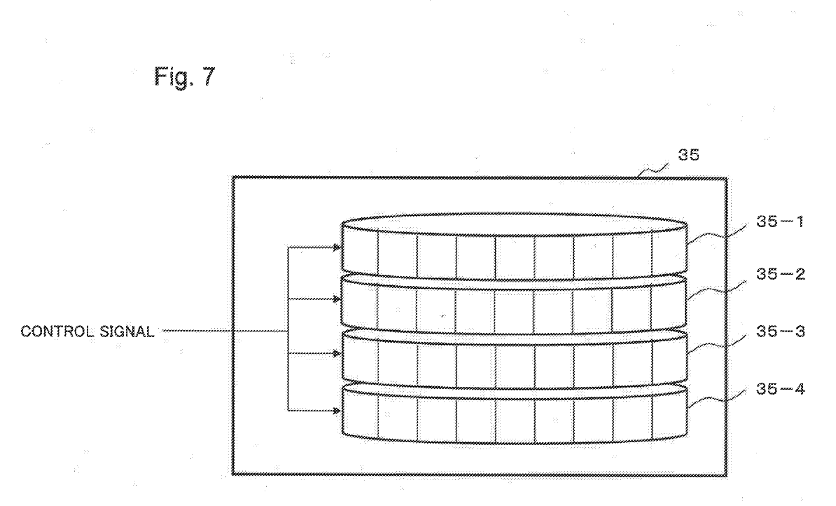

FIG. 7 illustrates an example of the configuration of the rearrangement storage device 35. The rearrangement storage device 35 is configured using a ring register. The rearrangement storage device 35 illustrated in FIG. 7 is configured using four ring registers from a ring register 35-1 to a ring register 35-4. The four ring registers each receive the control signal and are respectively controlled independently.

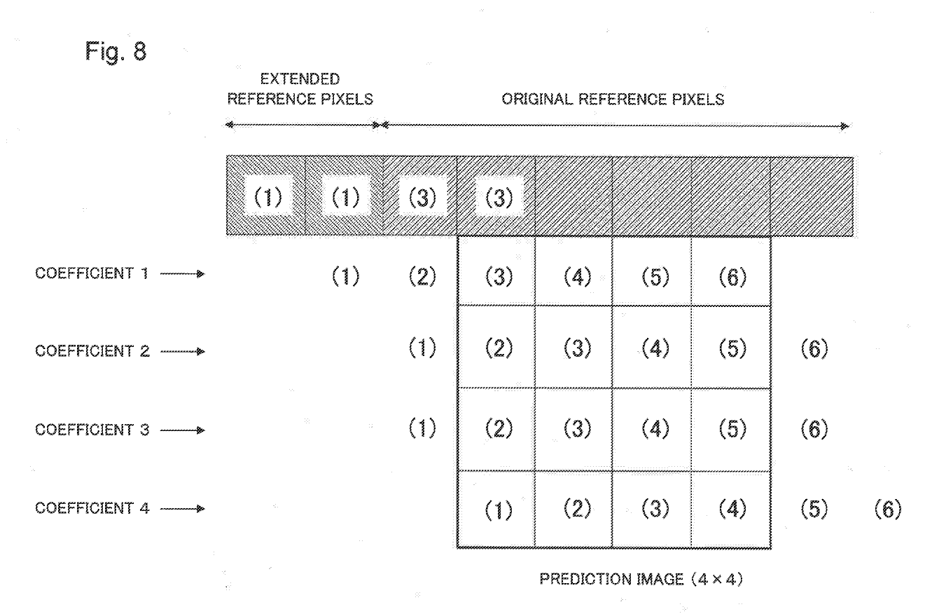

Next, a method for generating an intra prediction image in the intra prediction-image generation circuit 30 will be described. FIG. 8 illustrates the positions of reference pixels used for generating the prediction pixels and the positions of generated prediction pixels. Among the prediction pixels illustrated in FIG. 8, pixel positions with the same number correspond to prediction pixels generated from the same reference pixels. The prediction pixel generated from the same reference pixels are generated in parallel by four prediction-pixel generation processing circuits from the prediction-pixel generation processing circuit 34-1 to the prediction-pixel generation processing circuit 34-4.

The numbers assigned to the respective reference pixels illustrated in FIG. 8 represents the positions of reference pixels necessary for generating the prediction pixels with the same number. For example, the reference pixels necessary for generating prediction pixels “3” are reference pixels with the number “3”. When the reference pixels used for generating the prediction pixels are not present at the corresponding coordinates, for example, when the prediction pixels with “1” illustrated in FIG. 8 are generated, adjacent reference pixels are extended and used. For example, prediction pixels are generated assuming that reference pixels of the same pixel data as the pixel data of the adjacent reference pixels are present at the coordinates that are referred to when the prediction pixels are generated.

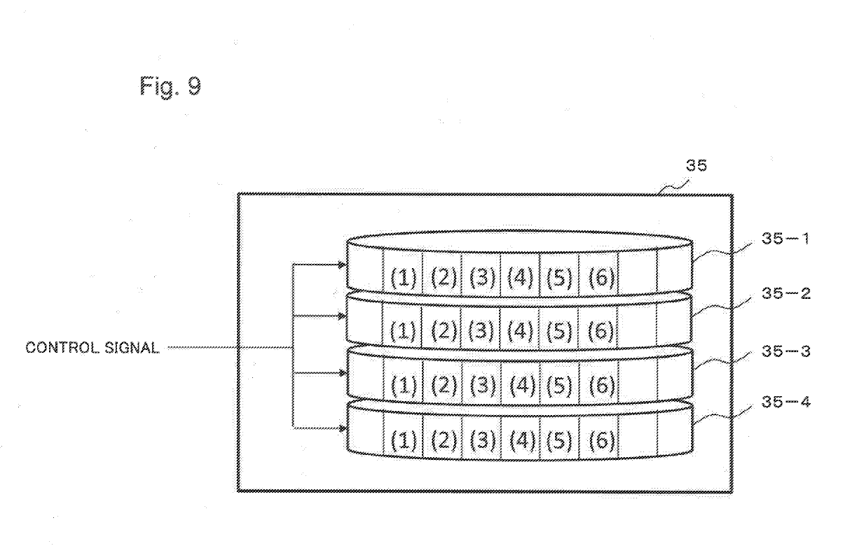

FIG. 9 illustrates an example of a method for storing the generated prediction pixels in the rearrangement storage device 35. In the example illustrated in FIG. 9, the prediction pixels generated in parallel are stored in the same column. Then, after the entire pixels are shifted by one, the next prediction pixel is further stored. By storing the prediction pixels as described above, the rearrangement storage device 35 stores, in the same column, the prediction pixels generated based on the reference pixels with the same number in FIG. 9.

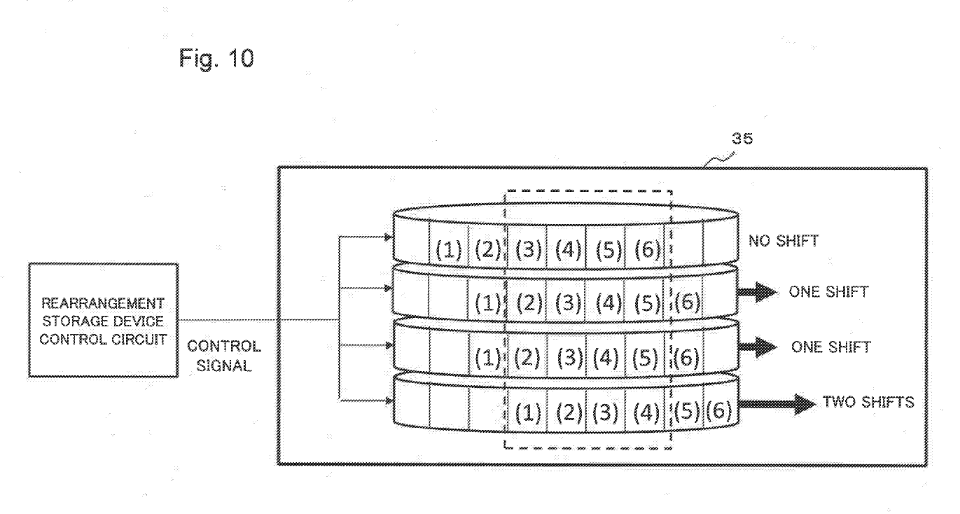

FIG. 10 illustrates a method for generating the prediction image from the prediction pixels stored as illustrated in FIG. 9. As illustrated in FIG. 9, a ring register 35-2 and a ring register 35-3 are shifted rightward by one and a ring register 35-4 is shifted rightward by two, so that the intra prediction image similar to the prediction image illustrated in FIG. 8 is generated in a part surrounded by a dashed line. The number of shifts and the target ring register are controlled by a control signal generated by the rearrangement storage device control circuit 36.

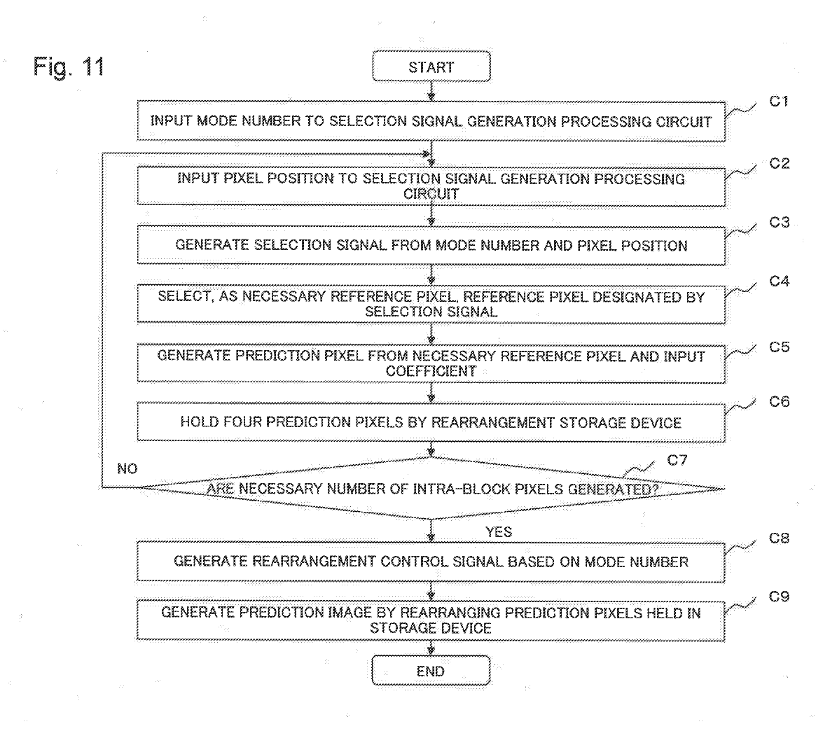

Next, the operation for generating the intra prediction image in the intra prediction-image generation circuit 30 will be described. FIG. 11 illustrates a flowchart of an operation flow when the intra prediction image is generated in the intra prediction-image generation circuit 30.

Step C1 in FIG. 11 corresponds to step A1 in FIG. 4. Step C2 in FIG. 11 corresponds to step A2 in FIG. 4. Step C3 corresponds to step A3. Step C4 corresponds to step A4. Step C5 corresponds to step A5. Step C6 in FIG. 11 corresponds to step A6 in FIG. 4. Step C7 corresponds to step A7. Step C8 corresponds to step A8. Step C9 corresponds to step A9.

First, a signal indicating information about a mode number is input to the selection signal generation processing circuit 32 (step C1). A signal indicating information about a pixel position is input to the selection signal generation processing circuit 32 (step C2). Upon receiving the information about the mode number and the pixel position, the selection signal generation processing circuit 32 generates the selection signal S32 on the basis of the input information about the mode number and the pixel position (step C3). The selection signal generation processing circuit 32 sends the generated selection signal S32 to the selection circuit 33.

Upon receiving the selection signal S32, the selection circuit 33 selects, as necessary reference pixels, two reference pixels designated by the selection signal S32 in the reference pixel signal S31 input from the storage device 31 (step C4). The reference pixel data selected as the necessary reference pixels are input as necessary pixel signals S33-1 and S33-2, respectively, to the four prediction-pixel generation processing circuits 34.

Upon receiving the two necessary reference pixel signals S33, the prediction-pixel generation processing circuits 34 each generate the prediction pixel by using the input data of the necessary reference pixels and coefficients externally input. Since the four prediction-pixel generation processing circuits 34 each generate the prediction pixel, four prediction pixels in total are generated (step C5). The four prediction-pixel generation processing circuits 34 send the generated prediction pixels respectively to the rearrangement storage device 35 as the prediction pixel signal S34.

Upon receiving the four prediction pixel signals S34-1 to S34-4, the rearrangement storage device 35 holds the four prediction pixels in total which are received from the four prediction-pixel generation processing circuits 34, respectively (step C6). When the input prediction image is held, the rearrangement storage device 35 determines whether or not all the prediction pixels necessary for generating the intra prediction image having 4×4 target blocks are generated.

When the necessary number of prediction pixels are not generated (No in step C7), the process returns to step C2 to obtain the next pixel position and the operation from step C2 to step C6 is carried out. In step C2, the mode number in the same coding target block is not changed, and thus the mode number obtained in step C1 is continuously used.

When all the necessary prediction pixels are generated (Yes in step C7), the rearrangement storage device 35 starts the operation of step C8 and subsequent steps for generating the prediction image.

The rearrangement storage device control circuit 36 generates the rearrangement control signal S35 for generating the intra prediction image by rearranging the prediction pixels, which are held in the rearrangement storage device 35, in accordance with the input mode number (step C8). Upon generating the rearrangement control signal S35, the rearrangement storage device control circuit 36 sends the generated rearrangement control signal S35 to the rearrangement storage device 35.

Upon receiving the rearrangement control signal S35, the rearrangement storage device 35 rearranges the intra prediction pixels, which are held in the rearrangement storage device 35, on the basis of the rearrangement control signal S35, thereby generating the intra prediction image having 4×4 blocks (step C9). Upon generating the intra prediction image, the rearrangement storage device 35 outputs the generated intra prediction image.

The intra prediction-image generation circuit 30 of this example embodiment has a configuration in which necessary reference pixels are input in parallel to the four prediction-pixel generation processing circuits 34. In the intra prediction-image generation circuit 30 of this example embodiment, four intra prediction pixels can be simultaneously generated using the same reference pixels, so that the number of selectors related to the input of the prediction-pixel generation processing circuits. Further, since the number of selectors is reduced, the circuit area is reduced.

In the intra prediction-image generation circuit 30 of this example embodiment, four reference pixels that are simultaneously generated are held in the rearrangement storage device 35. The intra prediction-image generation circuit 30 of this example embodiment has a configuration in which after the necessary number of pixels for generating the intra prediction image are held, the ring registers in the rearrangement storage device 35 are operated according to the control signal based on the mode number so that the prediction pixels can be rearranged. Accordingly, the intra prediction-image generation circuit 30 of this example embodiment eliminates the need for providing a selector when the intra prediction image of the block to be processed is generated from the generated intra prediction pixels, which leads to a reduction in circuit size.

Note that in the above examples of this example embodiment, ring registers are used as an example of the rearrangement storage device 35. However, the rearrangement storage device 35 may be configured using a randomly accessible storage device. With such a configuration, upon receiving the rearrangement control signal S35, the rearrangement storage device 35 generates, from the rearrangement control signal S35, an address for reading out data in a part surrounded by a dashed line in FIG. 10. The rearrangement storage device 35 reads out data according to the generated address, thereby obtaining advantageous effects similar to those of the above examples in this example embodiment.

### Third Example Embodiment

### Configuration of Third Example Embodiment

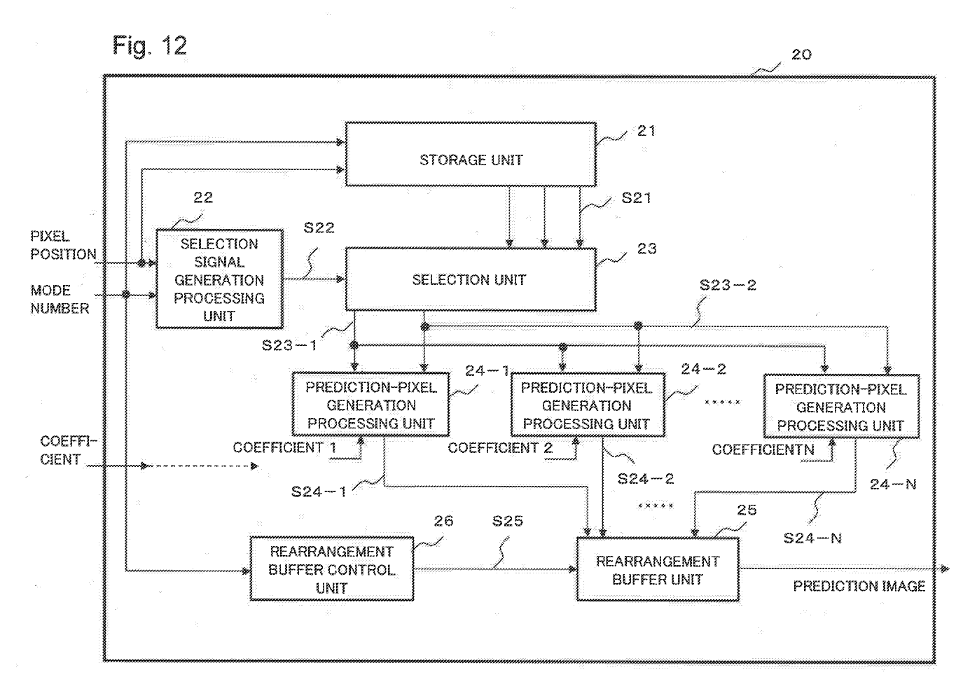

A third example embodiment of the present invention will be described in detail with reference to the drawings. FIG. 12 illustrates an outline of a configuration of an intra prediction-image generation device 20 of this example embodiment. The intra prediction-image generation device 20 of this example embodiment is characterized in that the storage unit has a data shifting function. In the intra prediction-image generation device 20 of this example embodiment, the storage unit has the data shifting function, which makes it possible to reduce the number of signal lines between selection units from the storage unit.

The intra prediction-image generation device 20 of this example embodiment includes a storage unit 21, a selection signal generation processing unit 22, a selection unit 23, a prediction-pixel generation processing unit 24, a rearrangement buffer unit 25, and a rearrangement buffer control unit 26.

The configurations and functions of the selection signal generation processing unit 22, the prediction-pixel generation processing unit 24, the rearrangement buffer unit 25, and the rearrangement buffer control unit 26 are similar to the units with the same name in the second example embodiment. A reference pixel signal S21, a selection signal S22, a necessary reference pixel signal S23, a prediction pixel signal S24, and a rearrangement control signal S25 have functions similar to the signals with the same name in the second example embodiment.

The storage unit 21 has a function of holding data of reference pixels. Further, the storage unit 21 has a function of selecting reference pixels on the basis of the information about the mode number and the pixel position externally input, and outputting the selected reference pixels.

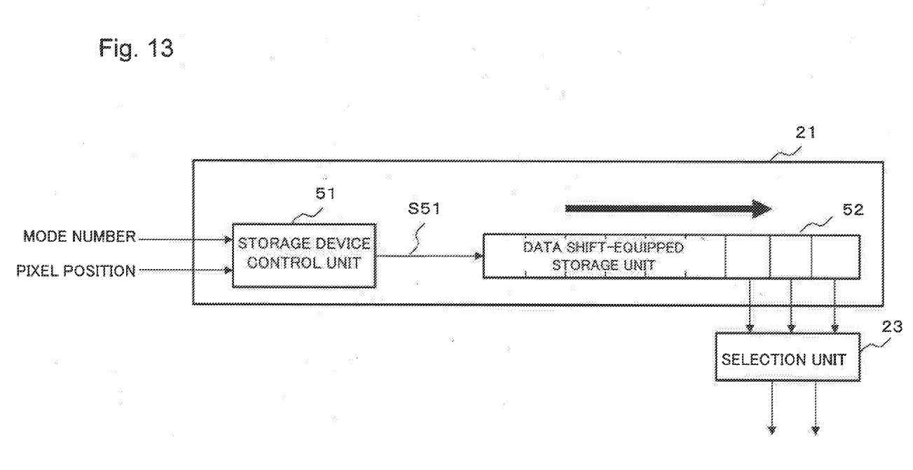

FIG. 13 illustrates the outline of the configuration of the storage unit 21. As illustrated in FIG. 13, the storage unit 21 includes a storage device control unit 51 and a data shift-equipped storage unit 52. The storage device control unit 51 generates a storage device control signal S51 for controlling the data shift-equipped storage unit 52 on the basis of the information about the mode number and the pixel position externally input. The data shift-equipped storage unit 52 stores the reference pixels in each region, and shifts the position where each reference pixel is stored on the basis of the storage device control signal S51.

The selection unit 23 has a function of selecting two reference pixels from a plurality of reference pixels on the basis of the selection signal S22, and outputting the selected reference pixels. The selection unit 23 receives, from the data shift-equipped storage unit 52, the reference pixel data stored in regions corresponding to first several pixels of the data stored in the data shift-equipped storage unit 52, as the reference pixel signal S21. In the example of FIG. 13, the selection unit 23 receives the reference pixel data stored in the regions corresponding to first three pixels of the data stored in the data shift-equipped storage unit 52. The selection unit 23 selects two pixels to be used as the reference pixels on the basis of the selection signal S22 sent from the selection signal generation processing unit 22, and sends the selected pixels to the prediction-pixel generation processing unit 24 as the necessary reference pixel signal S23.

### Operation of Third Example Embodiment

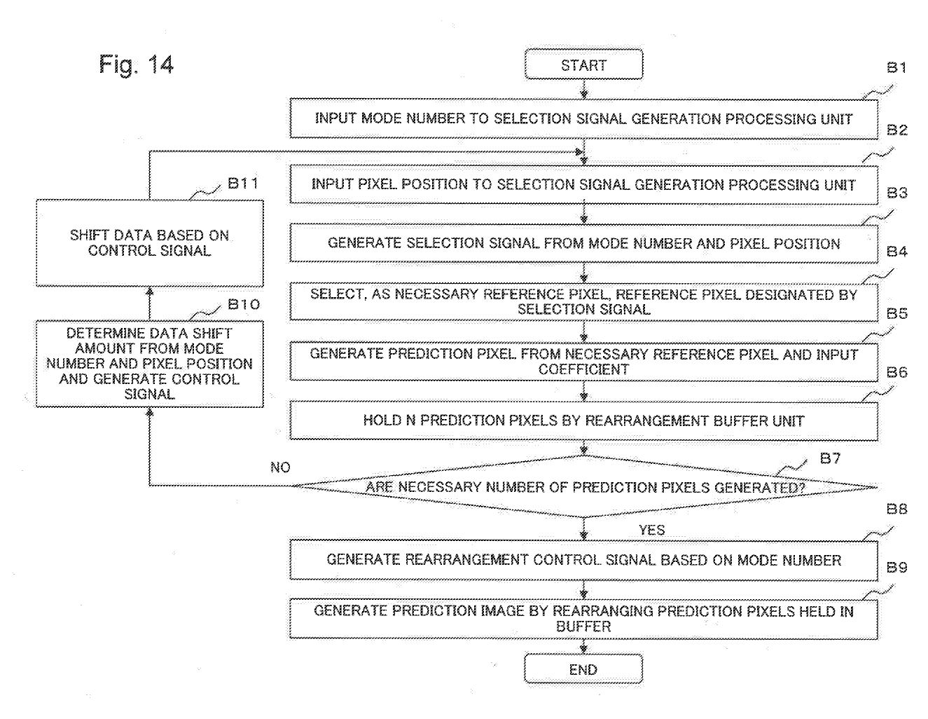

The operation of the intra prediction-image generation device 20 of this example embodiment will be described. FIG. 14 is a flowchart illustrating an outline of an operation flow of the intra prediction-image generation device 20 of this example embodiment.

First, information about a mode number and a pixel position is externally input to the storage unit 21. The storage device control unit 51 of the storage unit 21 sets the data shift-equipped storage unit 52 at an initial position on the basis of the information about the mode number and the pixel position. The data shift-equipped storage unit 52 sends, to the selection unit 23, pixel data corresponding to first several pixels of the held reference pixel data, as the reference pixel signal S21.

The signal indicating information about the mode number is also input to the selection signal generation processing unit 22 (step B1). The signal indicating information about the pixel position is also input to the selection signal generation processing unit 22 (step B2). Upon receiving the information about the mode number and the pixel position, the selection signal generation processing unit 22 generates the selection signal S22 on the basis of the input information about the mode number and the pixel position (step B3). The selection signal generation processing unit 22 sends the generated selection signal S22 to the selection unit 23.

Upon receiving the reference pixel signal S21 and the selection signal S22, the selection unit 23 selects two signals designated by the selection signal S22 from the reference pixel signal S21 indicating the reference pixel, like in the second example embodiment (step B4). Similarly, the intra prediction-image generation device 20 carries out an operation from step B5 to B9 similar to the operation from step A5 to step A9 of the second example embodiment.

In the operation from step B5 to B9, when the necessary number of prediction pixels for generating a prediction image are not generated after the operation for generating the prediction pixels in step B6 is finished (No in step B7), the intra prediction-image generation device 20 operates as follows.

When the necessary number of prediction pixels for generating a prediction image are not generated after the processing in step B6 is finished (No in step B7), the storage device control unit 51 generates the storage device control signal S51 indicating a data shift amount (step B10). The storage device control unit 51 determines the data shift amount on the basis of the mode number and the pixel position, and generates the storage device control signal S51.

Upon generating the storage device control signal S51, the storage device control unit 51 sends the generated storage device control signal S51 to the data shift-equipped storage unit 52.

Upon receiving the storage device control signal S51, the data shift-equipped storage unit 52 carries out an operation for shifting the stored data on the basis of the information about the data shift amount included in the signal (step B11). When the data shift amount indicated by the storage device control signal S51 is 0, the data shift-equipped storage unit 52 does not shift the data. When the data stored in the data shift-equipped storage unit 52 are shifted, the signal indicating the reference pixels corresponding to the first several pixels after shifting is sent to the selection unit 23. When the reference pixel signal S21 is input to the selection unit 23, the operation from step B2 is repeated.

### Advantageous Effects of Third Example Embodiment

In the intra prediction-image generation device 20 of this example embodiment, the reference pixels are held in the data shift-equipped storage unit 52. Further, the selection unit 23 receives the reference pixels corresponding to the first several pixels among the reference pixels stored in the data shift-equipped storage unit 52. The reference pixels stored in the first several pixels are controlled in such a manner that the storage device control unit 51 sets the data shift amount for reading out the necessary reference pixels on the basis of the mode number and the pixel position. The selection unit 23 selects two necessary reference pixels from the reference pixels corresponding to the input several pixels. With such a configuration, the intra prediction-image generation device 20 of this example embodiment makes it possible to reduce the number of signals indicating reference pixels input to selectors of the selection unit 23, which leads to a reduction in the circuit size associated with the selectors.

### Specific Examples of Third Example Embodiment

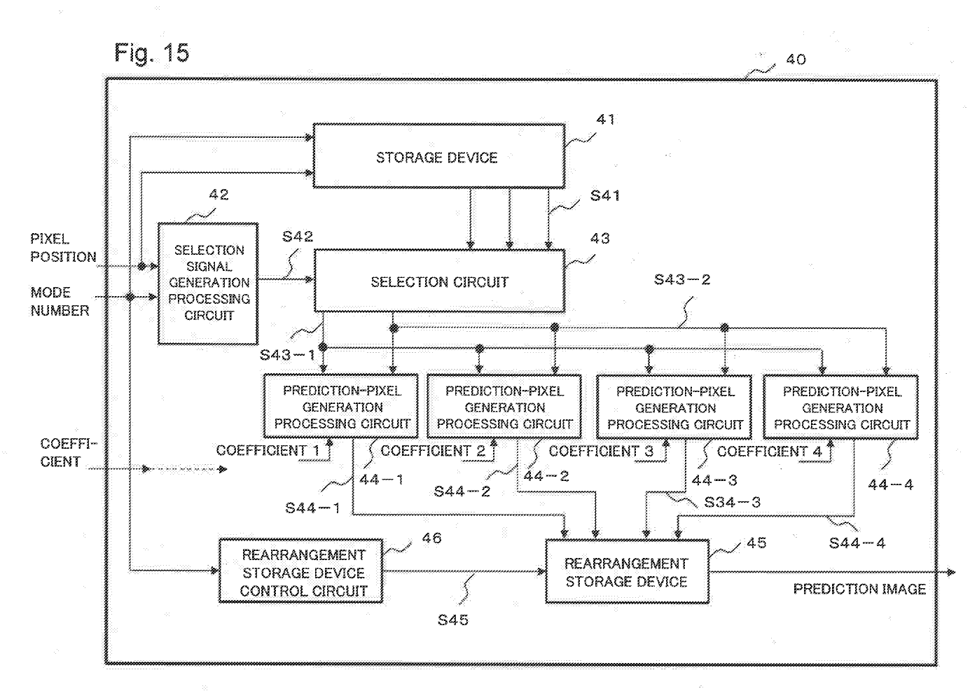

Next, the intra prediction-image generation device 20 of this example embodiment will be described using more specific examples. FIG. 15 illustrates a more detailed configuration of the intra prediction-image generation device 20 of this example embodiment as an intra prediction-image generation circuit 40.

As illustrated in FIG. 15, the intra prediction-image generation circuit 40 includes a storage device 41, a selection signal generation processing circuit 42, a selection circuit 43, a prediction-pixel generation processing circuit 44, a rearrangement storage device 45, and a rearrangement storage device control circuit 46. The intra prediction-image generation circuit 40 includes four prediction-pixel generation processing circuits 44 from a prediction-pixel generation processing circuit 44-1 to a prediction-pixel generation processing circuit 44-4.

The intra prediction-image generation circuit 40 corresponds to the intra prediction-image generation device 20 when N=4 holds. The storage device 41 corresponds to the storage unit 21 of the intra prediction-image generation device 20. The selection signal generation processing circuit 42 corresponds to the selection signal generation processing unit 22 of the intra prediction-image generation device 20. The selection circuit 43 corresponds to the selection unit 23 of the intra prediction-image generation device 20. The prediction-pixel generation processing circuits 44-1 to 44-4 respectively correspond to the prediction-pixel generation processing units 24-1 to 24-N of the intra prediction-image generation device 20 when N=4 holds. The rearrangement storage device 45 corresponds to the rearrangement buffer unit 25 of the intra prediction-image generation device 20. The rearrangement storage device control circuit 46 corresponds to the rearrangement buffer control unit 26 of the intra prediction-image generation device 20.

A reference pixel signal S41 corresponds to the reference pixel signal S21. A selection signal S42, a necessary reference pixel signal S43, a prediction pixel signal S44, and a rearrangement control signal S45 correspond to the selection signal S22, the necessary reference pixel signal S23, the prediction pixel signal S24, and the rearrangement control signal S25, respectively.

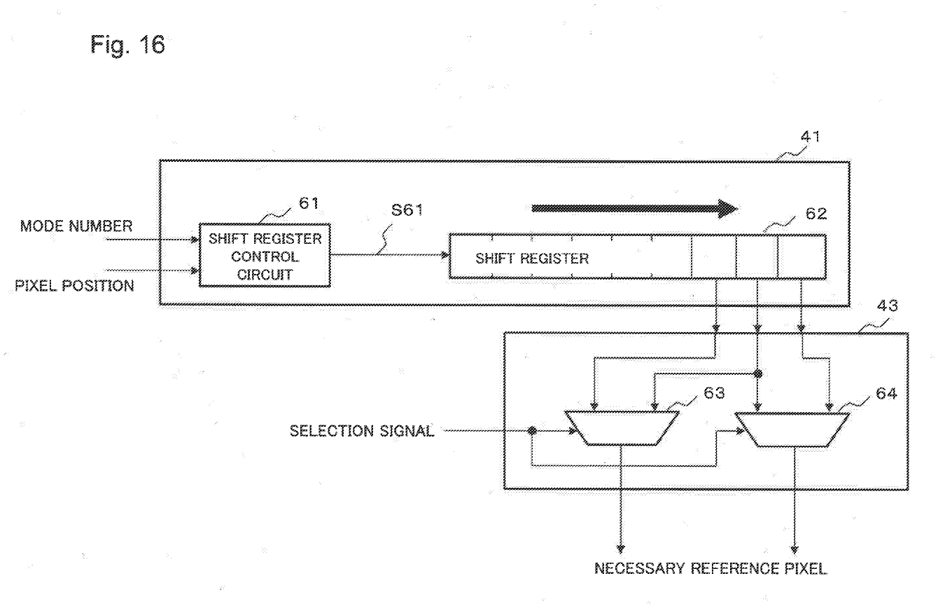

FIG. 16 illustrates an example of the configurations of the storage device 41 and the selection circuit 43. As illustrated in FIG. 16, the storage device 41 includes a shift register control circuit 61 and a shift register 62. The shift register 62 stores the reference pixels. The shift register control circuit 61 generates a shift register control signal S61 for controlling the shift register 62 on the basis of the input information about the mode number and generated pixel position.

The shift register 62 that holds reference pixels shifts the held data in accordance with the shift register control signal S61. As illustrated in FIG. 8, in the example where the prediction pixels labeled “1” to “6” are generated, when the prediction pixels are generated in numerical order of the labels “1” to “6”, the regions storing the necessary reference pixel are shifted rightward by substantially one pixel. The shift register control circuit 61 can control the shift register 62 to output the necessary reference pixels to the selection circuit 43 without shifting the data in the shift register 62 to a large extent.

The selection circuit 43 includes a selector 63 and a selector 64. The selector 63 and the selector 64 output one signal selected from two input signals. In the example of FIG. 13, the first three reference pixels in the shift register 62 are input to the selection circuit 43, and the selection circuit 43 selects two necessary reference pixels from three pixels and sends the selected necessary reference pixels to the prediction-pixel generation processing circuit 44.

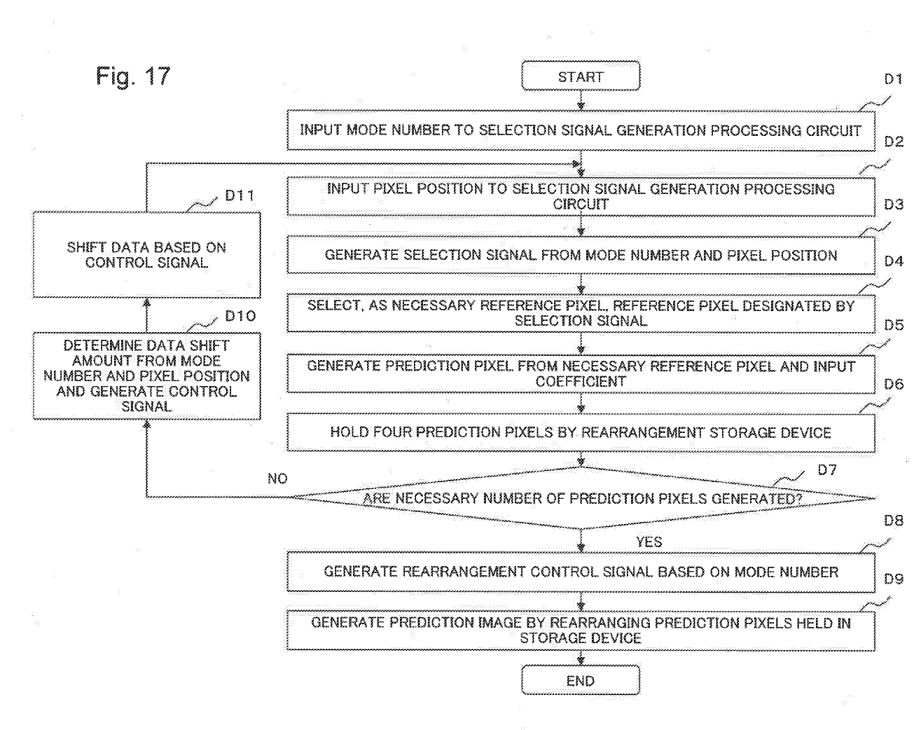

Next, the operation of the intra prediction-image generation circuit 40 will be described. FIG. 17 illustrates a flowchart of an outline of an operation flow of the intra prediction-image generation circuit 40.

Step D1 in FIG. 17 corresponds to step B1 in FIG. 14. Step D2 in FIG. 17 corresponds to step B2 in FIG. 14. Step D3 corresponds to step B3. Step D4 corresponds to step B4. Step D5 corresponds to step B5. Step D6 in FIG. 17 corresponds to step B6 in FIG. 14. Step D7 corresponds to step B7. Step D8 corresponds to step B8. Step D9 corresponds to step B9. Step D10 corresponds to step B10.

The operation from step D1 to step D9 is similar to the operation from step C1 to step C9 in FIG. 11. Therefore, an operation to be performed when the necessary number of prediction pixels for generating a prediction image are not generated after the operation for generating the prediction pixels in step D6 is finished (No in step D7) will be described in detail below.

When the necessary number of prediction pixels for generating the prediction image are not generated (No in step D7), the shift register control circuit 61 determines whether or not there is a need to shift the shift register 62 on the basis of the information about the mode number and the pixel position. If there is a need to shift the shift register, the shift register control circuit 61 calculates the shift amount of data in the shift register 62 and generates the shift register control signal S61 for controlling the shift register 62 (step D10). If there is no need to shift the shift register 62, the shift register control circuit 61 generates the shift register control signal S61 for setting the shift amount to “0”.

Upon generating the shift register control signal S61, the shift register control circuit 61 sends the generated signal to the shift register 62. Upon receiving the shift register control signal S61, the shift register 62 shifts the reference pixels on the basis of the shift register control signal S61 (step D11). When the shift amount indicated by the shift register control signal S61 is “0”, the shift register 62 does not shift the data. When the data are shifted, a signal indicating the first three reference pixels obtained after shifting is sent to the selection circuit 43. The number of reference pixels to be sent to the selection circuit 43 may be any number other than three. When the data are not shifted, the signal indicating the same reference pixels is continuously sent to the selection circuit 43. When the signal indicating the reference pixels is input to the selection circuit 43, the operation from step D2 is repeated.

In the intra prediction-image generation circuit 40 of this example embodiment, the shift register 62 stores the reference pixels. In the intra prediction-image generation circuit 40 of this example embodiment, the reference pixels are read out from only first three pixels of the shift register and are sent to the selection circuit 43. Further, the reference pixels to be sent to the selection circuit 43 can be changed by shifting the shift register. With this configuration, in the intra prediction-image generation circuit 40 of this example embodiment, the number of signals indicating reference pixels to be input to the selectors can be reduced. Consequently, in the intra prediction-image generation circuit 40 of this example embodiment, the circuit size can be reduced.

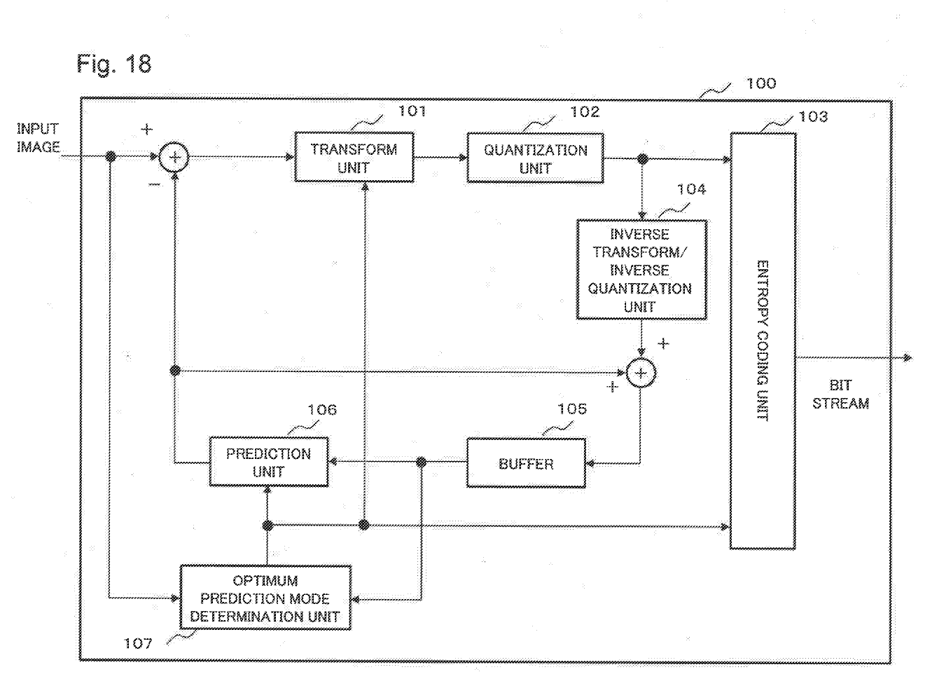

The prediction-image generation devices and circuits of the first to third example embodiments can be used for a moving image coding device as illustrated in FIG. 18. FIG. 18 illustrates an outline of a configuration of a moving image coding device 100 in which each of the prediction-image generation devices or circuits can be used as a prediction unit. The moving image coding device 100 illustrated in FIG. 18 is a device that performs video data coding processing using each CU (Coding Unit) in each frame of a digitized video as an input image, and outputs a bit stream.

The moving image coding device 100 illustrated in FIG. 18 includes a transform unit 101, a quantization unit 102, an entropy coding unit 103, an inverse transform/inverse quantization unit 104, a buffer 105, a prediction unit 106, and an optimum prediction mode determination unit 107. The circuit size of the entire moving image coding device 100 can be suppressed by using the prediction-image generation device or circuit of each of the example embodiments as the prediction unit 106 that performs intra prediction for generating the prediction image.

The transform unit 101 performs frequency transform of a prediction error signal generated by reducing the prediction signal from a signal indicating prediction error image data, i.e., an input image signal, on the basis of a TU (Transform Unit) quadtree structure determined by the optimum prediction mode determination unit 107. The transform unit 101 uses orthogonal transform of a predetermined block size based on frequency transform in transform coding of the prediction error signal. As the predetermined block size, for example, 4×4, 8×8, 16×16, or 32×32 is used. The transform unit 101 uses, for example, DST (Discrete Sine Transform) with an integer precision, which is approximated by integer arithmetic, for 4×4 TU of brightness components of intra CU, as orthogonal transform. For other TUs, the transform unit 101 uses DCT (Discrete Cosine Transform) with an integer precision approximated by integer arithmetic corresponding to the block size.

The quantization unit 102 quantizes an orthogonal transform coefficient supplied from the transform unit 101. The quantized orthogonal transform coefficient is also called a transform/quantization value. The entropy coding unit 103 performs entropy coding of the input data and outputs the coded data.

The inverse transform/inverse quantization unit 104 performs inverse quantization on a transform quantization value. Further, the inverse transform/inverse quantization unit 104 performs inverse transform on the inversely quantized orthogonal transform coefficient. The prediction signal is added to the inversely transformed prediction error image and is supplied to the buffer 105. The buffer 105 stores the image as a reference image.

The prediction unit 106 generates a prediction signal for the input image signal of the CU on the basis of the prediction mode and the prediction block determined by the optimum prediction mode determination unit 107. The prediction signal is generated based on intra prediction or inter prediction. The optimum prediction mode determination unit 107 determines, for each CTU (Coding Tree Unit), a combination of a prediction mode and a prediction block with a minimum coding cost.

When each unit operates in the manner as described above, the moving image coding device performs video data coding processing using each CU in each frame as an input image, and outputs a bit stream of compression-coded video data. Further, when the prediction-image generation device or circuit of each of the example embodiments is used as the prediction unit 106 of the moving image coding device 100, the circuit size of the moving image coding device can be suppressed.

The whole or part of the example embodiments disclosed above can be described as, but not limited to, the following supplementary notes.

### Supplementary Note 1

A prediction-image generation device including:

a storage means for holding a plurality of reference pixels;

a selection means for selecting, as necessary reference pixels, the reference pixels used for generating an intra prediction image on the basis of a mode number and a pixel position;

a prediction-pixel generation means for generating the plurality of prediction pixels in parallel processing based on the necessary reference pixels; and

a rearrangement buffer means for generating the prediction image by rearranging the prediction pixels based on the mode number, the prediction pixels being generated by the prediction-pixel generation means.

### Supplementary Note 2

The prediction-image generation device according to Supplementary Note 1, in which

the prediction image generation device includes a plurality of the prediction-pixel generation means, and

the plurality of prediction-pixel generation means generates the prediction pixels, respectively, using the same necessary reference pixels.

### Supplementary Note 3

The prediction-image generation device according to either Supplementary Note 1 or 2, in which the plurality of prediction-pixel generation means accepts different predetermined coefficients, respectively, and generates the prediction pixels based on the predetermined coefficients.

### Supplementary Note 4

The prediction-image generation device according to any one of Supplementary Notes 1 to 3, in which the storage means further includes:

a means for shifting data of the held reference pixels; and

a means for determining whether or not to shift the data on the basis of a mode number and a pixel position.

### Supplementary Note 5

The prediction-image generation device according to any one of Supplementary Notes 1 to 3, in which

the selection means includes two selectors, and

the necessary reference pixels respectively selected by the selectors are input to the prediction-pixel generation means.

### Supplementary Note 6

The prediction-image generation device according to any one of Supplementary Notes 1 to 5, in which

the rearrangement buffer means further includes a buffer storage means for shifting the held prediction pixels, and generates the prediction image by performing a shift operation to rearrange the prediction pixels.

### Supplementary Note 7

The prediction-image generation device according to Supplementary Note 6, in which

the rearrangement buffer means includes the buffer storage means with the same number as the plurality of prediction-pixel generation means, and the buffer storage means are respectively controlled independently.

### Supplementary Note 8

A prediction-image generation method including:

holding a plurality of reference pixels;

selecting, as necessary reference pixels, the reference pixels used for generating an intra prediction image on the basis of a mode number and a pixel position;

generating a plurality of prediction pixels in parallel processing based on the necessary reference pixels; and

generating the prediction image by rearranging the generated prediction pixels based on the mode number.

### Supplementary Note 9

The prediction-image generation method according to Supplementary Note 8, in which the prediction pixels are respectively generated using the same necessary reference pixels.

### Supplementary Note 10

The prediction-image generation method according to either Supplementary Note 8 or 9, in which

different predetermined coefficients are accepted and the prediction pixels are generated based on the predetermined coefficients.

### Supplementary Note 11

The prediction-image generation method according to any one of Supplementary Notes 8 to 10, further including:

determining whether or not to shift the data on the basis of a mode number and a pixel position; and

shifting data of the held reference pixels.

### Supplementary Note 12

The prediction-image generation method according to any one of Supplementary Notes 8 to 10, in which the necessary reference pixels respectively selected by two selectors are used for generating the prediction pixels.

### Supplementary Note 13

The prediction-image generation method according to any one of

Supplementary Notes 8 to 12, in which the prediction image is generated by shifting the held prediction pixels to rearrange the prediction pixels.

### Supplementary Note 14

The prediction-image generation method according to Supplementary Note 13, in which the prediction pixels are respectively held in storage elements respectively corresponding to a plurality of circuits configured to generate prediction pixels, and shift operations for the storage elements are respectively controlled independently.

### INDUSTRIAL APPLICABILITY

The present invention is applicable to systems, circuits and the like for performing intra prediction in moving image coding. The present invention is also applicable to compression coding of still images using intra prediction and the like.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-222747, filed on Oct. 31, 2014, the disclosure of which is incorporated herein in its entirety by reference.

### REFERENCE SIGNS LIST

1 Storage means

2 Selection means

3 Prediction-pixel generation means

4 Rearrangement buffer means

10 Intra prediction-image generation device

11 Storage unit

12 Selection signal generation processing unit

13 Selection unit

14 Prediction-pixel generation processing unit

15 Rearrangement buffer unit

16 Rearrangement buffer control unit

20 Intra prediction-image generation device

21 Storage unit

22 Selection signal generation processing unit

23 Selection unit

24 Prediction-pixel generation processing unit

25 Rearrangement buffer unit

26 Rearrangement buffer control unit

30 Intra prediction-image generation circuit

31 Storage device

32 Selection signal generation processing circuit

33 Selection circuit

34 Prediction-pixel generation processing circuit

35 Rearrangement storage device

36 Rearrangement storage device control circuit

37 Selector

38 Selector

40 Intra prediction-image generation circuit

41 Storage device

42 Selection signal generation processing circuit

43 Selection circuit

44 Prediction-pixel generation processing circuit

45 Rearrangement storage device

46 Rearrangement storage device control circuit

51 Storage device control unit

52 Data shift-equipped storage unit

61 Shift register control circuit

62 Shift register

63 Selector

64 Selector

101 Transform unit

102 Quantization unit

103 Entropy coding unit

104 Inverse transform/inverse quantization unit

105 Buffer

106 Prediction unit

107 Optimum prediction mode determination unit

S11 Reference pixel signal

S12 Selection signal

S13 Necessary reference pixel signal

S14 Prediction pixel signal

S15 Rearrangement control signal

S21 Reference pixel signal

S22 Selection signal

S23 Necessary reference pixel signal

S24 Prediction pixel signal

S25 Rearrangement control signal

S31 Reference pixel signal

S32 Selection signal

S33 Necessary reference pixel signal

S34 Prediction pixel signal

S35 Rearrangement control signal

S41 Reference pixel signal

S42 Selection signal

S43 Necessary reference pixel signal

S44 Prediction pixel signal

S45 Rearrangement control signal

S51 Storage device control signal

S61 Shift register control signal

1. A prediction-image generation device comprising:
a storage unit which holds a plurality of reference pixels;
a selection unit which selects, as a necessary reference pixel, the reference pixel used for generating an intra prediction image, based on a mode number and a pixel position;
a prediction-pixel generation unit which generates a plurality of the prediction pixels in parallel processing, based on the necessary reference pixel; and
a rearrangement buffer unit which generates the prediction image by rearranging the prediction pixels generated by the prediction-pixel generation unit, based on a mode number.

2. The prediction-image generation device according to claim 1, further comprising
a plurality of the prediction-pixel generation units, wherein
the plurality of the prediction-pixel generation units generate the prediction pixels, respectively, by using the same necessary reference pixel.

3. The prediction-image generation device according to claim 1, wherein a plurality of the prediction-pixel generation units accept different predetermined coefficients, respectively, and generate the prediction pixels based on the predetermined coefficients.

4. The prediction-image generation device according to claim 1, wherein the storage unit further shifts data of the held reference pixels and determines whether or not to shift the data, based on a mode number and a pixel position.

5. The prediction-image generation device according to claim 1, wherein
the selection unit includes two selectors, and
the necessary reference pixels respectively selected by the selectors are input to the prediction-pixel generation unit.

6. The prediction-image generation device according to claim 1, wherein
the rearrangement buffer unit further includes a buffer storage unit which shifts the held prediction pixels, and generates the prediction image by performing a shift operation to rearrange the prediction pixels.

7. The prediction-image generation device according to claim 6, wherein the rearrangement buffer unit includes the buffer storage units with the same number as a plurality of prediction-pixel generation units, and the buffer storage units are respectively controlled independently.

8. A prediction-image generation method comprising:
holding a plurality of reference pixels;
selecting, as a necessary reference pixel, the reference pixel used for generating an intra prediction image, based on a mode number and a pixel position;
generating a plurality of the prediction pixels in parallel processing, based on the necessary reference pixel; and
generating the prediction image by rearranging the generated prediction pixels, based on a mode number.

9. The prediction-image generation method according to claim 8, wherein the prediction pixels are respectively generated by using the same necessary reference pixel.

10. The prediction-image generation method according to claim 8, wherein different predetermined coefficients are accepted and the prediction pixels are generated based on the predetermined coefficients.

11. The prediction-image generation method according to claim 8, further comprising:
determining whether or not to shift the data, based on a mode number and a pixel position; and
shifting data of the held reference pixels.

12. The prediction-image generation method according to claim 8, wherein the necessary reference pixels respectively selected by two selectors are used for generating the prediction pixels.

13. The prediction-image generation method according to claim 8, wherein the prediction image is generated by shifting the held prediction pixels to rearrange the prediction pixels.

14. The prediction-image generation method according to claim 13, wherein the prediction pixels are respectively held in storage elements respectively corresponding to a plurality of circuits configured to generate prediction pixels, and shift operations for the storage elements are respectively controlled independently.
